(19) United States
(12) Patent Application Publication
(10) Pub. No.: US 2012/0072545 A1
(43) Pub. Date: Mar. 22, 2012

(54) REMOTE MAINTENANCE AND MONITORING SERVICE FRAMEWORK FOR HETEROGENEOUS DEVICE AND SYSTEM

(75) Inventors: Kwang Il LEE, Daejeon (KR); Jun Hee Park, Daejeon (KR); Hae Sook Jeon, Daejeon (KR); Kyeong Deok Moon, Daejeon (KR)

(73) Assignee: ELECTRONICS AND TELECOMMUNICATIONS RESEARCH INSTITUTE, Daejeon (KR)

(21) Appl. No.: 13/234,533

(22) Filed: Sep. 16, 2011

(30) Foreign Application Priority Data
Sep. 17, 2010 (KR) 10-2010-0091887

(51) Int. Cl. G06F 15/16

(52) U.S. Cl. 709/219

(57) ABSTRACT

Disclosed are a remote maintenance and monitoring service framework for a heterogeneous device and a heterogeneous system. According to exemplary embodiments of the present invention, a common maintenance service framework for a heterogeneous device and a heterogeneous system is provided through a network, and as a result, a maintenance manager can perform remote maintenance without visiting the site, thereby saving time and cost. Further, remote maintenance management through a network can be provided without installing an exclusive line and giving a load to the local network. In addition, the heterogeneous device and system are commonly managed regardless of types of devices so as to remarkably reduce complexity of maintenance and management.

### CROSS-REFERENCE TO RELATED APPLICATIONS

This application claims priority under 35 U.S.C. §119 to Korean Patent Application No. 10-2010-0091887, filed on Sep. 17, 2010, in the Korean Intellectual Property Office, the disclosure of which is incorporated herein by reference in its entirety.

### TECHNICAL FIELD

The present invention relates to a remote maintenance and monitoring service framework for a heterogeneous device and a heterogeneous system, and more particularly, to a remote maintenance and monitoring service framework for a heterogeneous device and a heterogeneous system that allows the heterogeneous device and the system to be remotely controlled, maintained, and monitored through a network.

### BACKGROUND

A known maintenance service of a system or industrial equipment is limited to a simple and general scope and a scope which can be performed by a local manager who is dispatched for system maintenance is also limited. However, in general, when errors or failures occur in the industrial equipment or the system, a manger who possesses high-level technology, such as a system or equipment developer should directly handle most of the errors or failures. In addition, most of the industrial devices or systems are installed and operated in places which are difficult for a maintenance manager to access. Further, even if the places are easy for the maintenance manager to access, it takes a long time and much cost for the maintenance manager to solve problems by directly visiting the places.

In order to solve the problem, the technology to remotely manage the industrial devices and systems by using a network and a computer has appeared. However, the currently provided network based remote monitoring and maintenance service for the industrial devices is very limited and has several problems. First, monitoring operations and current conditions of the devices and systems should be performed on the site. That is, the related art has a problem in that an exclusive line is installed or load of a local network increases.

Further, most of the maintenance services are dependent on the devices. That is, since a device operator cannot commonly manage heterogeneous devices, the device operator should provide different maintenance services to individual devices, thereby increasing the complexity thereof.

### SUMMARY

An exemplary embodiment of the present invention provides a global maintenance service framework including a user maintenance module and a global server. The user maintenance module includes: a first mapping unit mapping a service in order to convert the service into a message; a storage unit storing device information including operation conditions and profiles of systems and devices for maintenance; a user interface receiving a request for a first service from a user and transferring a result for the requested first service to the user; a first transaction managing unit extracting a message corresponding to the requested first service from the first mapping unit and generating a first transaction including the extracted message; and a first transaction processing unit reading the device information from the storage unit or requesting a second service in order to process the message included in the first transaction. The global server includes: a second mapping unit mapping a service in order to convert the service into a message; a global DB unit storing device information including operation conditions and profiles of systems and devices for maintenance; a user maintenance interface receiving a request for a second service and transferring a result for the requested second service to a user; a second transaction managing unit extracting a message corresponding to the requested second service from the second mapping unit and generating a second transaction including the extracted message; a second transaction processing unit reading the device information from the storage unit or requesting a third service in order to process the message included in the second transaction; and a local maintenance interface transmitting the requested third service and receiving a result for the third service.

The first transaction processing unit may judge whether the user maintenance module processes the message included in the first transaction, and read the device information from the storage unit when the user maintenance module processes the message and request the second service when the user maintenance module does not process the message.

Another exemplary embodiment of the present invention provides a local maintenance service framework including a local server and a local maintenance module. The local server includes: a third mapping unit mapping a service in order to convert the service into a message; a communication unit receiving a request for a third service and a result for the received third service; a local DB unit storing device information including operation conditions and profiles of systems and devices for maintenance; a third transaction managing unit extracting a message corresponding to the requested third service from the third mapping unit and generating a third transaction including the extracted message; a third transaction processing unit reading the device information from the local DB unit or requesting a fourth service in order to process the message included in the third transaction; and a standard interface transferring the requested fourth service and receiving a result for the fourth service. The local maintenance module process the request for the fourth service received through the standard interface.

The third transaction processing unit may judge whether the local server processes the message included in the third transaction, and read the device information from the local DB unit when the local server processes the message and request the fourth service when the local server does not process the message.

Yet another exemplary embodiment of the present invention provides a remote maintenance service framework including a global maintenance service framework and a local maintenance service framework.

Other features and aspects will be apparent from the following detailed description, the drawings, and the claims.

### BRIEF DESCRIPTION OF THE DRAWINGS

FIG. 1 is an overall configuration diagram of a remote maintenance service framework.

FIG. 2 is a configuration diagram of a user maintenance module.

FIG. 3 is a configuration diagram of a global server.

FIG. 4 is a configuration diagram of a local maintenance service framework.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

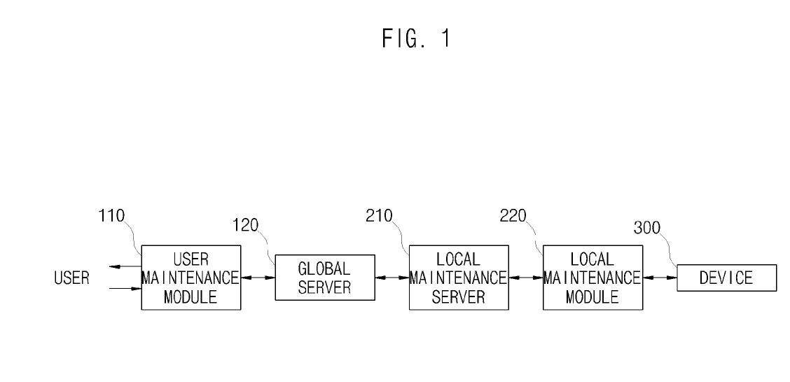

Referring to FIG. 1, a remote maintenance service framework according to an exemplary embodiment of the present invention includes a user maintenance module 110, a global server 120, a local server 210, a local maintenance module 220, and a device for maintenance (hereinafter, referred to as a ‘device 300’).

The user maintenance module 110 receives a service request from a user. When the user maintenance module 110 can directly process the requested service, the user maintenance module 110 processes the service and thereafter, provides the service processing result in a form for the user to understand, When the user maintenance module 110 cannot directly process the requested service, the user maintenance module 110 requests the service to the global server 120 and receives the service processing result to provide the corresponding result in the form for the user to understand.

The global server 120 receives the service request from the user maintenance module 110. When the global server 120 can directly process the requested service, the global server 120 processes the service and thereafter, transfers the result to the user maintenance module 110. When the global server 120 cannot directly process the service, the global server 120 requests the service to the local server 210 and receives the result and transfers the received result to the user maintenance module 110.

The local server 210 receives the service request from the global server 120. When the local server 210 can directly process the requested service, the local server 210 processes the service and thereafter, transfers the result to the global server 120. When the local server 210 cannot directly process the service, the local server 210 requests the service to the local maintenance module 220 and transfers the result to the global server 120.

The local maintenance module 220 receives the service request from the local server 210. When the local maintenance module 220 receives a request for controlling the device 300 from the local server 210, the local maintenance module 220 controls the device 300 according to the request and provides the result to the local server 210. Further, when the local maintenance module 220 receives a request for information on the device 300 from the local server 210, the local maintenance module 220 provides the corresponding information to the local server 210.

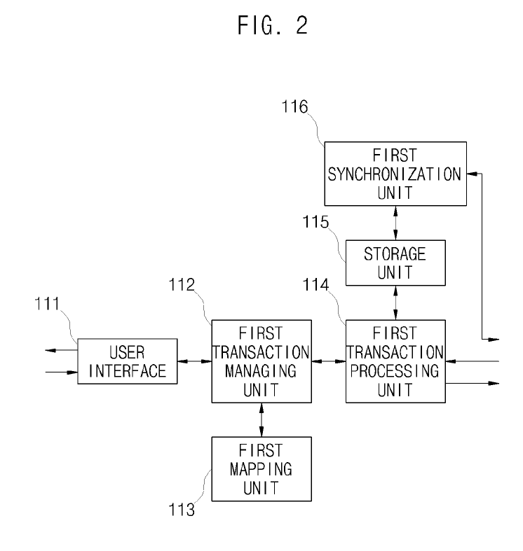

Referring to FIG. 2, the user maintenance module 110 according to the exemplary embodiment of the present invention includes a user interface 111, a first transaction managing unit 112, a first mapping 113, a storage unit 115, a first transaction processing unit 114, and a first synchronization unit 116.

The user interface 111 receives a request for a first service from a user and transfers a result for the requested first service to the user. The user interface 111 may be implemented based on a graphic user interface (GUI) or based on the WEB. When the user interface 111 is implemented based on the WEB, the user interface 111 may include a web server.

The first mapping unit 113 maps the requested service in order to convert the corresponding service into a message. Each service request may be configured by at least one standardized primitive message. That is, the first mapping unit 113 connects at least one standardized primitive message for one service request so as to convert the requested service into the message.

The storage unit 115 stores device information including operation conditions and profiles of systems and devices 300 for maintenance. The profile includes a maker, a model number, an operating system (OS), configuration information and other basic information.

The first transaction managing unit 112 extracts a message corresponding to the first service requested by the user from the first mapping unit 113 and generates a first transaction including the extracted message. Further, the first transaction managing unit 112 performs analysis to convert at least one of a response message and a response file to the first service requested by the user into a result for the first service. That is, since the first transaction managing unit 112 receives the result for the service requested by the user in a message or file type, the first transaction managing unit 112 performs analysis to convert the result for the service into the form for the user to understand.

Further, the first transaction managing unit 112 further performs at least one of history management, condition management, error handling management, and termination management for the generated first transaction. The first transaction managing unit 112 manages current and past conditions of the first transaction and when the first transaction is abnormally terminated, the first transaction managing unit 112 notifies the abnormal termination to a service and a system associated therewith. For example, when the first transaction is abnormally terminated, the first transaction managing unit 112 may notify the abnormal termination to the first service. In addition, when the condition of the first transaction is not changed for a predetermined time, the first transaction managing unit 112 may forcibly terminate the first transaction.

The service may be configured by at least one transaction and one transaction may be configured by at least one message.

The first transaction generated by the first transaction managing unit 112 may be configured by any one of a unidirectional message including an event, two request-response messages, three request-response-result messages, four request-response-actionreqeust-actionresponse messages, and five request-response-actionrequest-actionresponse-result messages.

One transaction may have different numbers of messages depending on a characteristic of the requested service. The transaction may include a transaction configured by only one message, such as an event for notifying occurrence of a predetermined event, a request-response transaction to request predetermined information and wait for a response thereto, a request-response-result transaction to request a service like requesting a file (getFile) and receive a response thereto and thereafter, when the service is available, receive the result afterwards, a request-response-actionrequest-actionresponse transaction to request a service like transferring a file (putFile) and receive the result and thereafter, request a detailed action for the service and receive a response thereto, and a request-response-actionrequest-actionresponse-actionresult transaction to request the service and receive the result and thereafter, request the detailed action for the service and receive a response thereto and when the response is success, receive the result.

The first transaction processing unit 114 reads the device information from the storage unit 115 or requests a second service in order to process the message included in the first transaction. The first transaction processing unit 114 judges whether the user maintenance module 110 can process the message included in the first transaction. If the user maintenance module 110 can process the message, the first transaction processing unit 114 reads the device information from the storage unit 115 and if the user maintenance module 110 cannot process the message, the first transaction processing unit 114 requests the second service.

The first synchronization unit 116 is synchronized by at least one of a periodic message transmitting method and an event-type method. That is, the first synchronization unit 116 periodically requests and receives the device information for synchronization. In addition, the first synchronization unit 116 updates the device information of the storage unit 115 as the received device information. As another exemplary embodiment, the first synchronization unit 116 requests the device information to the first transaction managing unit 112 and the first transaction managing unit 112 generates a new transaction according to the request for the device information to transfer the new generated transaction to the global server 120.

As described above, the first synchronization unit 116 synchronizes the storage unit 115 and a global db unit 124 with each other. In this case, the first synchronization unit 116 may request information on a field modified in the global DB unit 124 in order to minimize an information transfer size and may periodically request information on the entirety of the global DB.

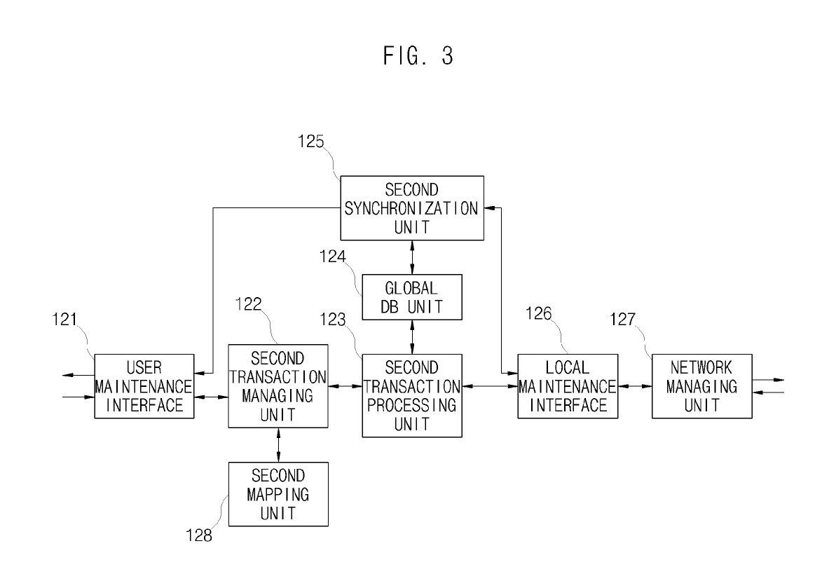

Referring to FIG. 3, the global server 120 according to the exemplary embodiment of the present invention includes a user maintenance interface 121, a second transaction managing unit 122, a second mapping unit 128, a second transaction processing unit 123, a global DB unit 124, a second synchronization unit 125, a local maintenance interface 126, and a network managing unit 127.

The user maintenance interface 121 receives a request for the second service from the first transaction processing unit 114 and transfers a result for the requested second service.

The second mapping unit 128 maps the requested service in order to convert the corresponding service into a message. Each service request may be configured by at least one standardized primitive message. That is, the second mapping unit 128 connects at least one standardized primitive message for one service request so as to convert the requested service into the message.

The global DB unit 124 stores device information including operation conditions and profiles of a device 300 and a system for maintenance. The profile includes a maker, a model number, an operating system (OS), configuration information and other basic information.

The second transaction managing unit 122 extracts a message corresponding to the second service requested by the second mapping unit 128 and generates a second transaction including the extracted message. Further, the second transaction managing unit 122 further performs at least one of history management, condition management, error handling management, and termination management for the generated second transaction. The second transaction managing unit 122 manages current and past conditions of the second transaction and when the second transaction is abnormally terminated, the second transaction managing unit 122 notifies the abnormal termination to a service and a system associated therewith. For example, when the second transaction is abnormally terminated, the second transaction managing unit 122 may notify the abnormal termination to the second service. In addition, when the condition of the second transaction is not changed for a predetermined time, the second transaction managing unit 122 may forcibly terminate the second transaction.

The service may be configured by at least one transaction and one transaction may be configured by at least one message.

The second transaction generated by the second transaction managing unit 122 may be configured by any one of a unidirectional message including an event, two request-response messages, three request-response-result messages, four request-response-actionreqeust-actionresponse messages, and five request-response-actionrequest-actionresponse-result messages. A detailed description thereof is the same as the detailed description in the first transaction managing unit 112.

The second transaction processing unit 123 reads the device information from the global DB unit 124 or requests a third service in order to process the message included in the second transaction. The second transaction processing unit 123 judges whether the global server 120 can process the message included in the second transaction. If the global server 120 can process the message, the second transaction processing unit 123 reads the device information from the global DB unit 124 and if the global server 120 cannot process the message, the second transaction processing unit 123 requests the third service.

The local maintenance interface 126 transmits the requested third service and receives a result for the third service. The local maintenance interface 126 provides an interface between the global server 120 and the local server 210.

The second synchronization unit 125 is synchronized by at least one of a periodic message transmitting method and an event-type method. That is, the second synchronization unit 125 generates and transfers an event when the device information of the global DB unit 124 is changed. As another exemplary embodiment, when the device information of the global DB unit 124 is changed, the second synchronization unit 125 transfers the changed device information to the second transaction managing unit 122 and the second transaction managing unit 122 may generate a new transaction of an event type and transfer the generated new transaction to the user maintenance module 110.

The second synchronization unit 125 generates an event and transfers the generated event to the user maintenance module 110 to notify to the user maintenance module 110 that the device information is changed when the device information of the global DB unit 124 is changed. When the first synchronization unit 116 receives the event indicating that the device information of the global DB unit 124 is changed, the first synchronization unit 116 requests and receives the device information of the global DB unit 124, and updates the device information of the storage unit 115 as the received device information. Through such a process, the storage unit 115 and the global DB unit 124 are synchronized with each other. In this case, the first synchronization unit 116 requests only the changed information among the device information of the global DB unit 124 to minimize the information transfer size.

Further, the second synchronization unit 125 periodically requests and receives the device information through the local maintenance interface 126, and updates the device information of the global DB unit 124. As another exemplary embodiment, the second synchronization unit 125 requests the device information to the second transaction managing unit 122 and the second transaction managing unit 122 generates a new transaction according to the request for the device information to transfer the new generated transaction to the local server 210.

The network managing unit 127 manages a communication channel for transmission and reception through the local maintenance interface 126. That is, the network managing unit 127 forms a communication channel between the global server 120 and the local server 210 to transmit and receive a service request, a message, and a file. The network managing unit 127 allocates a unique identifier to the local server 210, and forms and manages a safe communication channel between the global server 120 and the local server 210. Further, the network managing unit 127 recognizes the local server 210 and performs connection management to the local server 210. Recognition of the local server 210 may be identified through an IP address of the local server 210, the unique ID of the local server 210, and allocation of a unique ID to a site where the local server 210 is present. In the connection management, connection and disconnection of the global server 120 and the local server 210, notification of a change of connection with the global server 120, and the like may be managed.

A global maintenance service framework includes the user maintenance module 110 and the global server 120. The user maintenance module 110 and the global server 120 are as described above.

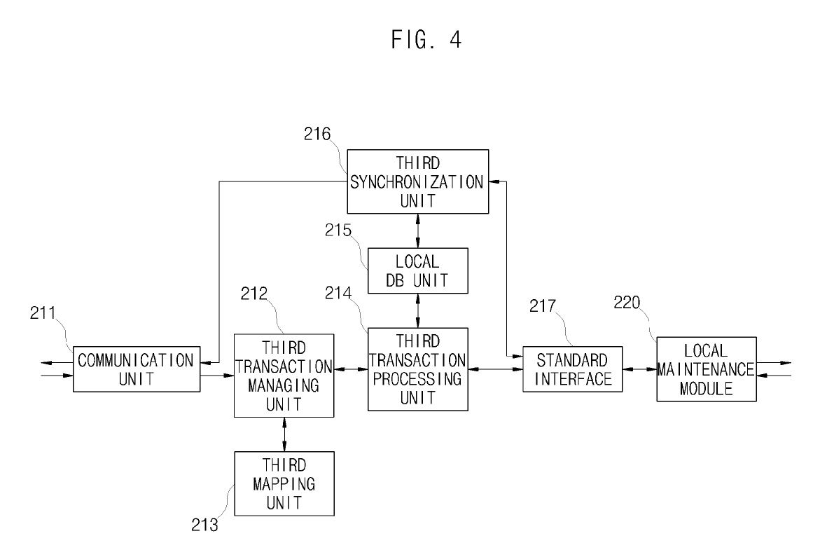

Referring to FIG. 4, the local server according to the exemplary embodiment of the present invention includes a communication unit 211, a third transaction managing unit 212, a third mapping unit 213, a third transaction processing unit 214, a local DB unit 215, a third synchronization unit 216, and a standard interface 217.

The third mapping unit 213 maps a service in order to convert the service into a message. Each service request may be configured by at least one standardized primitive message. That is, the third mapping unit connects at least one standardized message to each service in order to convert the requested service into the message.

The communication unit 211 receives a request for a third service and transmits a result for the received third service.

The global DB unit 215 stores device information including operation conditions and profiles of a device 300 and a system for maintenance, which are received from the local maintenance module 220. The profile includes a maker, a model number, an operating system (OS), configuration information and other basic information.

The third transaction managing unit 212 extracts a message corresponding to the requested third service from the third mapping unit 213 and generates a third transaction including the extracted message. Further, the third transaction managing unit 212 further performs at least one of history management, condition management, error handling management, and termination management for the generated third transaction. The third transaction managing unit 212 manages current and past conditions of the third transaction and when the third transaction is abnormally terminated, the third transaction managing unit notifies the abnormal termination to a service and a system associated therewith. For example, when the third transaction is abnormally terminated, the third transaction managing unit 212 may notify the abnormal termination to the second transaction. In addition, when the condition of the third transaction is not changed for a predetermined time, the third transaction managing unit 212 may forcibly terminate the third transaction.

The service may be configured by at least one transaction and one transaction may be configured by at least one message.

The third transaction generated by the third transaction managing unit 212 may be configured by any one of a unidirectional message including an event, two request-response messages, three request-response-result messages, four request-response-actionreqeust-actionresponse messages, and five request-response-actionrequest-actionresponse-result messages. A detailed description thereof is the same as the detailed description in the first transaction managing unit 112.

The third transaction processing unit 214 reads the device information from the global DB unit 215 or requests a fourth service in order to process the message included in the third transaction. The third transaction processing unit 214 judges whether the user maintenance module 110 can process the message included in the third transaction. If the user maintenance module 110 can process the message, the third transaction processing unit 214 reads the device information from the local DB unit 215 and if the user maintenance module 110 cannot process the message, the third transaction processing unit 214 requests the fourth service.

The third synchronization unit 216 is synchronized by at least one of a periodic message transmitting method and an event-type method. That is, the third synchronization unit 216 generates and transfers an event to the global server 120 when the device information of the global DB unit 215 is changed. As another exemplary embodiment, when the device information of the global DB unit 215 is changed, the third synchronization unit 216 transfers the changed device information to the third transaction managing unit 212 and the third transaction managing unit 212 may generate a new transaction of an event type and transfer the generated new transaction to the global server 120.

The third synchronization unit 216 generates an event and transfers the generated event to the global server 120 to notify that the device information is changed when the device information of the local DB unit 215 is changed. When the second synchronization unit 125 receives the event indicating that the device information of the local DB unit 215 is changed, the second synchronization unit 125 requests and receives the device information of the local DB unit 215, and updates the device information of the global DB unit 124 as the received device information. Through such a process, the global DB unit 124 and the local DB unit 215 are synchronized with each other. In this case, the second synchronization unit 125 requests only the changed information among the device information of the local DB unit 215 to minimize the information transfer size.

Further, the third synchronization unit 216 periodically requests and receives the device information through the standard interface 217, and updates the device information of the local DB unit 215. As another exemplary embodiment, the third synchronization unit 216 requests the device information to the third transaction managing unit 212 and the third transaction managing unit 212 generates a new transaction according to the request for the device information to transfer the new generated transaction to the local maintenance module 220.

The standard interface 217 transfers the requested fourth service and receives a result for the fourth service. The standard interface 217 provides a standardized interface to various heterogeneous devices 300. That is, the local server 210 and the local maintenance module 220 may request and transfer information regarding various devices 300 regardless of a make or a type through the standardized interface.

A local maintenance service framework includes the local server 210 and the local maintenance module 220.

The local server 210 is as described above.

The local maintenance module 220 processes the request for the fourth service received through the standard interface 217. When the local maintenance module 220 receives a request for controlling the device 300 from the local server 210, the local maintenance module 220 controls the corresponding device 300. Further, when the local maintenance module 220 receives a request for various information such as real-time monitoring of the device 300 from the local server 210, the local maintenance module 220 generates the information according to the request and provides the corresponding information to the local server 210.

A remote maintenance service framework includes the global maintenance service framework and the local maintenance service framework. The global maintenance service framework may include the user maintenance module 110 and the global server 120 and the local maintenance service framework may include the local server 210 and the local maintenance module 220.

According to the exemplary embodiments of the present invention, a common maintenance service framework for a heterogeneous device and a heterogeneous system is provided through a network, and as a result, a maintenance manager can perform remote maintenance without visiting the site, thereby saving time and cost. Further, remote maintenance management through a network can be provided without installing an exclusive line and adding load to the local network. In addition, the heterogeneous device and system are commonly managed regardless of the types of devices so as to remarkably reduce the complexity of maintenance and management.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A user maintenance module, comprising:
a first mapping unit mapping a service in order to convert the service into a message;
a storage unit storing device information including operation conditions and profiles of systems and devices for maintenance;
a user interface receiving a request for a first service from a user and transferring a result for the requested first service to the user;
a first transaction managing unit extracting a message corresponding to the requested first service from the first mapping unit and generating a first transaction including the extracted message; and
a first transaction processing unit reading the device information from the storage unit or requesting a second service in order to process the message included in the first transaction.

2. The user maintenance module of claim 1, wherein the first transaction processing unit judges whether the user maintenance module processes the message included in the first transaction, and reads the device information from the storage unit when the user maintenance module processes the message and requests the second service when the user maintenance module does not process the message.

3. The user maintenance module of claim 1, wherein the first transaction managing unit further performs analysis to convert at least one of a response message and a response file to the first service into a result for the first service.

4. The user maintenance module of claim 1, wherein the first transaction managing unit further performs at least one of history management, condition management, error handling management, and termination management for the first transaction.

5. The user maintenance module of claim 1, wherein the generated first transaction is configured by any one of a unidirectional message including an event, two request-response messages, three request-response-result messages, four request-response-actionreqeust-actionresponse messages, and five request-response-actionrequest-actionresponse-result messages.

6. The user maintenance module of claim 1, further comprising a first synchronization unit synchronized by at least one of a periodic message transmitting method and an event-type method.

7. The user maintenance module of claim 1, wherein the user interface is implemented by the WEB.

8. A global server, comprising:
a second mapping unit mapping a service in order to convert the service into a message;
a global DB unit storing device information including operation conditions and profiles of systems and devices for maintenance;
a user maintenance interface receiving a request for a second service and transferring a result for the requested second service to a user;
a second transaction managing unit extracting a message corresponding to the requested second service from the second mapping unit and generating a second transaction including the extracted message;
a second transaction processing unit reading the device information from the storage unit or requesting a third service in order to process the message included in the second transaction; and
a local maintenance interface transmitting the requested third service and receiving a result for the third service.

9. The global server of claim 8, wherein the second transaction processing unit judges whether the global server processes the message included in the second transaction, and reads the device information from the global DB unit when the global server processes the message and requests the third service when the global server does not process the message.

10. The global server of claim 8, wherein the second transaction managing unit further performs at least one of history management, condition management, error handling management, and termination management for the second transaction.

11. The global server of claim 8, wherein the generated second transaction is configured by any one of a unidirectional message including an event, two request-response messages, three request-response-result messages, four request-response-actionreqeust-actionresponse messages, and five request-response-actionrequest-actionresponse-result messages.

12. The global server of claim 8, further comprising a second synchronization unit synchronized by at least one of a periodic message transmitting method and an event-type method.

13. A global maintenance service framework, comprising a user maintenance module of claim 1 and a global server of claim 8.

14. A local server, comprising:
a third mapping unit mapping a service in order to convert the service into a message;
a communication unit receiving a request for a third service and a result for the received third service;
a local DB unit storing device information including operation conditions and profiles of systems and devices for maintenance;
a third transaction managing unit extracting a message corresponding to the requested third service from the third mapping unit and generating a third transaction including the extracted message;
a third transaction processing unit reading the device information from the local DB unit or requesting a fourth service in order to process the message included in the third transaction; and
a standard interface transferring the requested fourth service and receiving a result for the fourth service.

15. The local server of claim 14, wherein the third transaction processing unit judges whether the local server processes the message included in the third transaction, and reads the device information from the local DB unit when the local server processes the message and requests the fourth service when the local server does not process the message.

16. The local server of claim 14, wherein the third transaction managing unit further performs at least one of history management, condition management, error handling management, and termination management for the third transaction.

17. The local server of claim 14, wherein the generated third transaction is configured by any one of a unidirectional message including an event, two request-response messages, three request-response-result messages, four request-response-actionreqeust-actionresponse messages, and five request-response-actionrequest-actionresponse-result messages.

18. The local server of claim 14, further comprising a third synchronization unit synchronized by at least one of a periodic message transmitting method and an event-type method.

19. A local maintenance service framework, comprising:
a local server and a local maintenance module of claim 14,
wherein the local maintenance module processes a request for a fourth service.

20. A remote maintenance service framework, comprising a global maintenance service framework including a user maintenance module of claim 1 and a global server of claim 8 and a local maintenance service framework of claim 19.
